(19) United States
(12) Patent Application Publication
(10) Pub. No.: US 2020/0096617 A1
(43) Pub. Date: Mar. 26, 2020

(54) LIDAR DEVICE AND CONTROL METHOD THEREOF

(71) Applicant: SUTENG INNOVATION TECHNOLOGY CO., LTD., Shenzhen (CN)

(72) Inventor: Chunxin Qiu, Shenzhen (CN)

(21) Appl. No.: 16/616,642

(22) PCT Filed: Nov. 28, 2017
(86) PCT No.: PCT/CN2017/113313

§ 371 Date: Nov. 25, 2019

(30) Foreign Application Priority Data
May 25, 2017 (CN) 201710377473.7

(51) Int. Cl. G01S 7/481; G01S 7/4863; G02B 26/10; G02B 27/30

(52) U.S. Cl. CPC G01S 7/4817; G02B 27/30; G02B 26/101; G01S 7/4863

(57) ABSTRACT

The present application discloses a laser detection and ranging (LIDAR) device that includes: a laser emitter configured to emit an outgoing laser and a two-dimensional tilting mirror configured to change an optical path direction of the outgoing laser in a vertical dimension and a horizontal dimension. A LIDAR control method is also disclosed. The method include the steps of emitting, by a laser emitter, outgoing laser and changing, by a two-dimensional tilting mirror, an optical path direction of the outgoing laser in a vertical dimension and a horizontal dimension.

### TECHNICAL FIELD

The present invention relates to the field of detection, in particular to a lidar and a control method thereof.

### BACKGROUND

A LIDAR (Light Detection and Ranging) device is a radar system that uses a laser beam to detect characteristic measures of a target, such as its position and velocity. The working principle of a lidar is to first send a detection laser beam to the target, and then compare a received signal reflected from the target with the emitted signal. After proper processing of the comparison result, information about the target may be obtained, e.g. parameters of the target such as distance, azimuth, altitude, speed, attitude, and even shape.

In the prior art, a LIDAR device (simply referred to as lidar hereafter) requires multiple laser emitters if three-dimensional scanning, i.e. 360-degree scanning, is to be realized. A prior art lidar using a plurality of laser emitters is expensive, since laser emitters are costly. In addition, a prior art lidar has low vertical resolution even if multiple laser emitters are used, because the vertical resolution of the prior art lidar is determined by the number of laser emitters per unit length, and only a limited number of laser emitters can be arranged per unit length in the vertical direction since each laser emitter takes up a certain space.

### SUMMARY

In an embodiment of the present invention, a lidar and a control method thereof with reduced cost and improved vertical resolution are provided.

A lidar includes:

a laser emitter configured to emit an outgoing laser; and

a two-dimensional tilting mirror configured to change an optical path direction of the outgoing laser in a vertical dimension and in a horizontal dimension.

A lidar control method includes:

emitting, by a laser emitter, outgoing laser; and

changing, by a two-dimensional tilting mirror, an optical path direction of the outgoing laser in a vertical dimension and in a horizontal dimension.

In the above-mentioned lidar and control method thereof, costs can be saved since only one laser emitter is used. Meanwhile, a two-dimensional tilting mirror is adopted to change the optical path of an outgoing laser emitted by the laser emitter in a vertical dimension. Because the rotation speed of the two-dimensional tilting mirror is extremely fast, a number of laser beams can be distributed in the vertical dimension for scanning, thereby improving the vertical resolution of the lidar of the present invention. In addition, the two-dimensional tilting mirror can also change the direction of the optical path of the outgoing laser in a horizontal dimension, thereby enabling 360-degree three-dimensional scanning.

### BRIEF DESCRIPTION OF THE DRAWINGS

In order to more clearly illustrate the technical solutions in the embodiments of the present invention or the prior art, drawings accompanying the description of the embodiments or the prior art will be briefly described below. Obviously, the drawings in the following description are only illustrations of some embodiments of the present invention, and thereby drawings for other embodiments can be derived by those skilled in the art without exercising inventive skills.

FIG. 1 is a schematic structural view of a lidar according to an embodiment of the present invention;

FIG. 2 shows a spot diagram of single-point laser after passing through a two-dimensional tilting mirror;

FIG. 3 is a schematic structural view of a lidar according to an embodiment of the present invention; and

FIG. 4 is a flow chart showing a lidar control method according to an embodiment of the present invention.

### DETAILED DESCRIPTION

In order to facilitate understanding of the present invention, a more complete description thereof will be provided hereinafter with reference to the accompanying drawings. Although preferred embodiments of the present invention are shown in the drawings, the present invention may also be embodied in various forms and is not limited to the embodiments described herein. Rather, these embodiments are provided to facilitate a thorough and complete understanding of the present disclosure.

Unless otherwise defined, all technical and scientific terms used herein have the meaning as what is generally understood by those skilled in the art. The terminology used herein is only for description of specific embodiments, and is not intended to limit the present invention. The term “and/or” as used herein includes any and every combination of one or more of associated items being referred to.

The following embodiments of the present invention provide a lidar and a lidar control method that can reduce cost and improve vertical resolution.

Technical solutions of the embodiments of the present invention are described hereinafter with reference to the accompanying drawings for the embodiments of the present invention. It is noted that the described embodiments are not all of the embodiments of the present invention, just a part thereof. Other embodiments that can be derived by those skilled in the art on the basis of the embodiments of the present invention, without practicing inventive skills, also fall within the scope of the present invention.

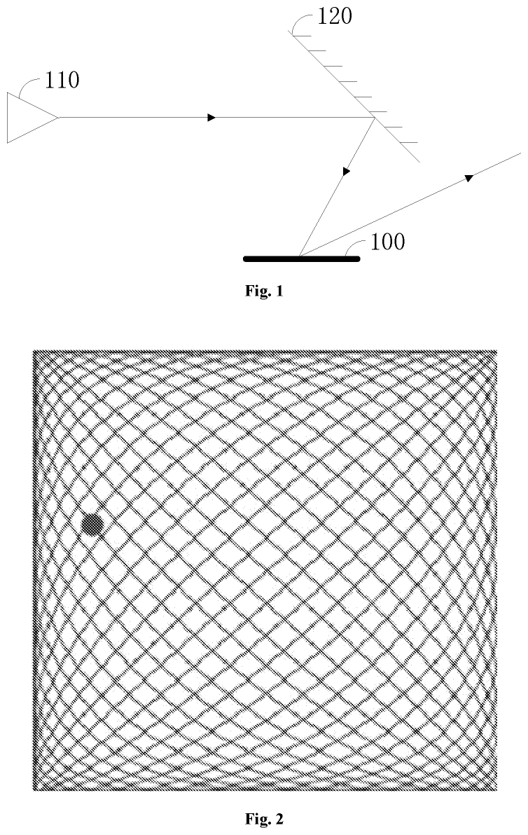

FIG. 1 is a schematic diagram of a lidar according to an embodiment of the present invention. As shown in FIG. 1, the lidar includes:

a laser emitter 110 configured to emit an outgoing laser; and

a two-dimensional tilting mirror 120 configured to change an optical path direction of the outgoing laser in a vertical dimension and in a horizontal dimension.

The two-dimensional tilting mirror 120 needs to load a driver during operation, and operates at a resonant frequency. The reflective surface of the two-dimensional tilting mirror 120 rotates at high speed in two axial directions, and by this scanning action, it transforms a one-point laser beam into a laser beam plane.

A commonly used galvanometer may be a MEMS (Micro-Electro-Mechanical System), or a mechanical galvanometer, or other functional units having the same or similar functions.

FIG. 2 shows a spot diagram of single-point laser passing through a two-dimensional tilting mirror. As shown in FIG. 2, there is one spot at the intersection of each two curves.

In an embodiment of the present invention, a lidar including a laser emitter and a two-dimensional tilting mirror is disclosed. In the embodiment of the present invention, costs can be saved since only one laser emitter is used. Meanwhile, a two-dimensional tilting mirror is adopted by the lidar of the present invention to change the optical path of an outgoing laser emitted by the laser emitter in a vertical dimension. Because the rotation speed of the two-dimensional tilting mirror is extremely fast, numerous laser beams can be distributed in the vertical dimension, thereby improving the vertical resolution of the lidar of the present invention. In addition, the two-dimensional tilting mirror can also change the direction of the optical path of the outgoing laser in the horizontal dimension, thereby enabling 360-degree three-dimensional scanning.

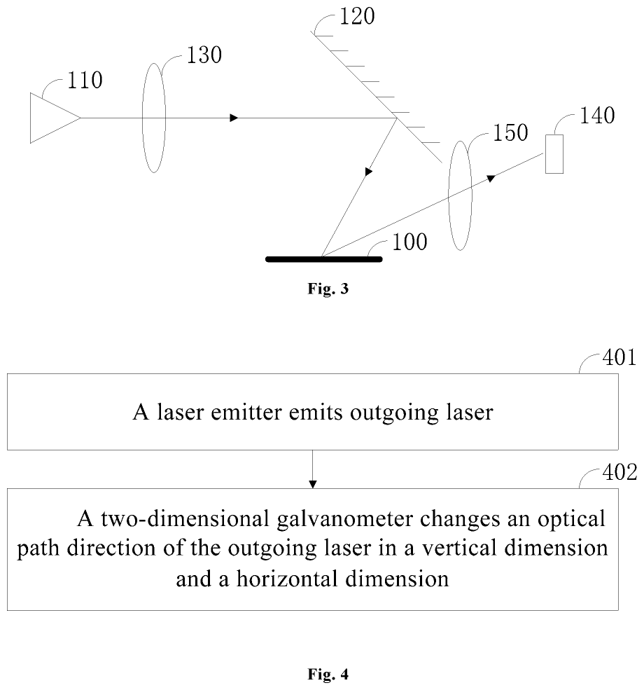

FIG. 3 is a schematic diagram of a lidar according to an embodiment of the present invention. As shown in FIG. 3, the lidar further includes a collimating unit 130, a receiver 140, and a focusing unit 150.

The collimating unit 130 is provided between the laser emitter 110 and the two-dimensional tilting mirror 120 and configured to collimate the outgoing laser emitted by the laser emitter 110.

In the embodiment of the present invention, the collimating unit 130 may be a collimating lens, and the collimating lens may be a single lens or a lens group composed of a plurality of lenses.

The receiver 140 is configured to receive a reflected laser, which is formed by the outgoing laser being reflected by an object to be detected after the optical path direction is changed.

The receiver 140 may be an area array receiver.

The area array receiver may be an APD (Avalanche Photo Diode) array. The APDs are evenly arranged on a plane. Once the reflected laser is received by the APD array, it is processed by a processor to generate a 3D image.

If the outgoing laser emitted from the laser 110 is deflected by the two-dimensional tilting mirror 120 before reaching the collimating unit 130, the two-dimensional tilting mirror can deflect a single-point laser onto an area. This is equivalent to the case that a large-angle incident light enters the collimating lens. To correct a large-angle incident light, multiple lenses are required, thereby increasing product cost and design difficulty, and causing attenuation of the outgoing laser. Therefore, in the embodiment of the present invention, the emitted laser is directly collimated by the collimating lens 130 before being deflected by the two-dimensional tilting mirror 120. Accordingly, the reflection of the laser will not introduce aberrations and the like, which reduces design difficulty and makes it unnecessary to reduce multiple lenses, thereby reducing costs.

The lidar of the embodiment of the present invention can reduce the costs of the lidar and improve the vertical resolution thereof.

Corresponding to the above lidar, an embodiment of the present invention further provides a lidar control method.

FIG. 4 is a flowchart of a lidar control method according to an embodiment of the present invention. As shown in FIG. 4, the method includes the following steps.

In step 401, a laser emitter emits an outgoing laser.

In step 402, a two-dimensional tilting mirror changes the optical path direction of the outgoing laser in a vertical dimension and a horizontal dimension.

Optionally, the method further includes:

collimating, by a collimating unit, the outgoing laser emitted by the laser emitter. The collimating unit is provided between the laser emitter and the two-dimensional tilting mirror.

Optionally, the method further includes:

receiving a reflected laser by a receiver. The reflected laser is formed by the outgoing laser being reflected by an object to be detected after the optical path direction is changed.

Optionally, the receiver is an area array receiver.

Optionally, the method further includes:

focusing the reflected laser by a focusing unit. The focusing unit is provided in front of the receiver, the reflected laser is formed by the outgoing laser being reflected by an object to be detected after the optical path direction is changed. The reflected laser that has been focused is received by the receiver.

The lidar control method of the embodiment of the present invention can reduce the cost of the lidar and improve the vertical resolution thereof.

Embodiments of the present invention disclose a lidar and a control method thereof, the lidar including a laser emitter and a two-dimensional tilting mirror. In the embodiments of the present invention, costs can be saved since only one laser emitter is used. Meanwhile, a two-dimensional tilting mirror is utilized by the lidar of the present invention to change an optical path of an outgoing laser emitted by the laser emitter in a vertical dimension. Because the rotation speed of the two-dimensional tilting mirror is extremely fast, numerous laser beams can be distributed in the vertical dimension, thereby improving the vertical resolution of the lidar of the present invention. In addition, the two-dimensional tilting mirror can also change the direction of the optical path of the outgoing laser in a horizontal dimension, thereby enabling 360-degree three-dimensional scanning.

It will be apparent to those skilled in the art that the technology in the embodiments of the present invention may be implemented by means of software plus necessary general hardware including general-purpose integrated circuits, general-purpose CPUs, general-purpose memories, general-purpose devices, and the like, and of course may be implemented by dedicated hardware including an application specific integrated circuit, a dedicated CPU, a dedicated memory, a dedicated component, etc., but in many cases the former is a better implementation. Based on such understanding, the technical solution in the embodiments of the present invention, in essence or in the part that contributes to the prior art, may be embodied in the form of a software product, which may be stored in a storage medium such as a Read-Only Memory (ROM), Random Access Memory (RAM), magnetic disk, optical disk, etc., including a number of instructions to enable a computer device (which may be a personal computer, server, or network device, etc.) to perform the methods described in various embodiments of the present invention or in certain portions of the embodiments.

The various embodiments in the specification are described in a progressive manner, the same or similar parts between the various embodiments may be referred to each other, and each embodiment focuses on the differences from the other embodiments. In particular, for the system embodiment, since it is basically similar to the method embodiment, the description is relatively simple, and the relevant parts may be referred to the description of the method embodiment.

Those skilled in the art can understand that all of or part of the flows of the above embodiments may be completed by a computer program that commands related hardware, and the program may be stored in a non-volatile computer readable storage medium, which, when executed, may include the flows of an embodiment of the methods as described above. The storage medium may be a magnetic disk, an optical disk, a read-only memory (ROM), or the like.

The technical features of the above-described embodiments may be arbitrarily combined. For the sake of brevity of description, not all possible combinations of the technical features in the above embodiments are described. However, as long as there is no contradiction between the combinations of these technical features, they should be considered as fallen within the scope of the specification.

The above-described embodiments are merely illustrative of several embodiments of the present invention with more specific and detailed description thereof, but are not to be construed as limiting the scope of the present invention. It should be noted that a number of variations and modifications may be made by those skilled in the art without departing from the spirit and scope of the present invention. Therefore, the scope of the present invention should be determined by the appended claims.

1. A lidar, comprising:
a laser emitter configured to emit an outgoing laser; and
a two-dimensional tilting mirror configured to change an optical path direction of the outgoing laser in a vertical dimension and in a horizontal dimension.

2. The lidar of claim 1, further comprising a collimating unit provided between the laser emitter and the two-dimensional tilting mirror and configured to collimate the outgoing laser emitted by the laser emitter.

3. The lidar of claim 1, further comprising a receiver configured to receive a reflected laser, wherein the reflected laser is formed by the outgoing laser being reflected by an object to be detected after the optical path direction is changed.

4. The lidar of claim 3, wherein the receiver is an area array receiver.

5. The lidar of claim 3, further comprising a focusing unit provided in front of the receiver and configured to focus the reflected laser, wherein the reflected laser is formed by the outgoing laser being reflected by an object to be detected after the optical path direction is changed, and the reflected laser that has been focused is received by the receiver.

6. The lidar of claim 1, wherein the two-dimensional tilting mirror is a MEMS galvanometer or a mechanical galvanometer.

7. The lidar of claim 2, wherein the collimating unit is a single lens or a lens group composed of a plurality of lenses.

8. The lidar of claim 4, wherein the area array receiver is an APD array.

9. A lidar control method, comprising:
emitting, by a laser emitter, outgoing laser; and
changing, by a two-dimensional tilting mirror, an optical path direction of the outgoing laser in a vertical dimension and in a horizontal dimension.

10. The method of claim 9, further comprising:
collimating, by a collimating unit, the outgoing laser emitted by the laser emitter, wherein the collimating unit is provided between the laser emitter and the two-dimensional tilting mirror.

11. The method of claim 9, further comprising:
receiving, by a receiver, a reflected laser, wherein the reflected laser is formed by the outgoing laser being reflected by an object to be detected after the optical path direction is changed.

12. The method of claim 11, wherein the receiver is an area array receiver.

13. The method of claim 11, further comprising:
focusing, by a focusing unit, the reflected laser, wherein the focusing unit is provided in front of the receiver, the reflected laser is formed by the outgoing laser being reflected by an object to be detected after the optical path direction is changed, and the reflected laser that has been focused is received by the receiver.

14. The method of claim 9, wherein the two-dimensional tilting mirror is a MEMS galvanometer or a mechanical galvanometer.

15. The method of claim 10, wherein the collimating unit is a single lens or a lens group consisting of a plurality of lenses.

16. The method of claim 12, wherein the area array receiver is an APD array.
